(19) United States
(12) Patent Application Publication
(10) Pub. No.: US 2026/0359836 A1
(43) Pub. Date: Nov. 12, 2026

(54) SYSTEM AND METHOD FOR PERSONALIZED CONVERSATIONAL EXPERIENCES TRIGGERED BY INTERACTIVE ADVERTISEMENTS WITH HUMAN AGENT ESCALATION

(71) Applicant: Ramarao Pemmaraju, Old Bridge, NJ (US)

(72) Inventor: Ramarao Pemmaraju, Old Bridge, NJ (US)

(21) Appl. No.: 19/670,226

(22) Filed: May 7, 2026

Related U.S. Application Data
(60) Provisional application No. 63/802,325, filed on May 8, 2025.

(51) Int. Cl. G06Q 30/015; G06Q 10/1093; G06Q 20/24; G06Q 20/32; G06Q 30/0251; G06Q 30/0601; H04L 51/02

(52) U.S. Cl. CPC G06Q 30/015; G06Q 10/1093; G06Q 20/24; G06Q 20/322; G06Q 30/0253; G06Q 30/0643; H04L 51/02

(57) ABSTRACT

This disclosure relates generally to system and method for personalized conversational experiences triggered by interactive advertisements with human agent escalation. Advertisement interaction metadata is received from a user device in response to a user interacting with a digital advertisement. The metadata is routed to microsite that generates a personalized conversational interface. The conversational interface supports one or more interaction modalities, including a text, voice, and video based communication, and is transmitted to the user device in real time. The conversational interface contextually relevant transaction options to facilitate user actions. The system continuously monitors user interaction with the conversational interface to determine an engagement intent and evaluates whether the engagement satisfies predefined escalation conditions. Upon dissatisfaction, the system escalates the interaction to a human agent through communication channels. The disclosed approach improves user engagement, enables seamless transition between automated and human-assisted interactions, and enhances efficiency in digital advertising and transaction workflows.

### CROSS-REFERENCE TO RELATED APPLICATIONS

This U.S. patent application claims priority under the benefit of U.S. Provisional Application No. 63/802,325 titled “System and Method for Personalized Conversational Experiences Triggered by Interactive Advertisements with Human Agent Escalation”, filed 8 May 2025, the disclosure of which is incorporated herein by reference.

### TECHNICAL FIELD

The disclosure herein generally relates to the field of digital advertising and conversational artificial intelligence (AI), and, more particularly, to system and method for personalized conversational experiences triggered by interactive advertisements with human agent escalation.

### BACKGROUND

Digital advertising has evolved significantly with the widespread adoption of programmatic buying, real-time bidding, and advanced audience targeting. Major advertising ecosystems, including demand-side platforms (DSPs), the Google Display Network, and Meta Ads, enable advertisers to deliver highly targeted campaigns across diverse digital channels. However, despite these advances in targeting and delivery, the interaction model within advertisement units remains fundamentally limited.

Most modern advertising platforms impose strict security, sandboxing, and performance constraints on ad creatives. These restrictions typically prohibit the execution of arbitrary or persistent JavaScript, including embedded third-party widgets such as interactive chatbots or conversational agents. As a result, advertisements are generally confined to predefined formats such as images, videos, or lightweight interactive elements without the ability to host fully functional, stateful conversational experiences within the ad container itself.

Due to these limitations, advertisers commonly rely on redirect-based engagement models, wherein a user clicking on an advertisement is routed to an external landing page. These landing pages are often static or only minimally dynamic, resulting in a discontinuity between the ad context and the post-click experience. This transition introduces friction, increases drop-off rates, and reduces the effectiveness of personalization, as the contextual signals associated with the advertisement (e.g., campaign metadata, audience segment, creative variant) are not fully leveraged to tailor the user experience in real time.

Existing chatbot solutions, while increasingly prevalent, are typically deployed within websites, mobile applications, or messaging platforms as standalone features. These implementations are generally not tightly integrated with upstream advertising systems and lack the ability to dynamically adapt their behavior based on specific advertisement interactions. Furthermore, such systems often operate in isolation, without seamless mechanisms for escalating user interactions to human agents within the same conversational context, leading to fragmented user journeys and reduced satisfaction.

Attempts to bridge this gap have been limited. Some solutions employ generic landing pages with embedded chat widgets; however, these approaches fail to preserve ad-level intent and do not provide true real-time personalization at the moment of engagement. Others rely on external messaging platforms, which introduce additional user friction and dependency on third-party ecosystems.

Accordingly, there exists a need for an improved system and method that overcomes the technical constraints of advertising platforms while enabling rich, personalized, and continuous conversational experiences. Such a system should be capable of being triggered directly from advertisement interactions, leveraging contextual data associated with the ad impression or click event, and instantiating a tailored conversational interface. Additionally, the system should support seamless escalation from automated conversational agents to human representatives within a unified interaction flow, thereby enhancing engagement, improving conversion rates, and delivering a more coherent and satisfying user experience.

### SUMMARY

Embodiments of the present disclosure present technological improvements as solutions to one or more of the above-mentioned technical problems recognized by the inventors in conventional system. This Summary is provided to introduce a selection of concepts in a simplified form that is further described below in the Detailed Description. Summary is not intended to identify key features or essential features of the claimed subject matter, nor is it intended to be used to limit the scope of the claimed subject matter.

According to aspects of the disclosure, a method for personalized conversational experiences triggered by interactive advertisements with human agent escalation is provided. The method receives from a user device, an advertisement interaction metadata generated in response to a user interaction with a digital advertisement. Further, the advertisement interaction metadata is routed to a microsite server configured to generate a personalized conversational interface. Then, the microsite server generates the personalized conversational interface using the advertisement interaction metadata, wherein the personalized conversational interface comprising at least one of a text-based interaction, a voice-based interaction, a video-based interaction, and an user interface element representing an AI-driven conversational agent or a combination thereof. Further, the personalized conversational interface is transmitted to the user device in response to the user interaction, and the personalized conversational interface including at least one transaction option. Finally, the user interaction with the personalized conversational interface is monitored to determine an engagement intent and in response to determine if the engagement intent satisfies a predefined escalation condition, and escalating the personalized conversational interface to a human agent via at least one of the text-based interaction, the voice-based interaction, the video-based interaction, and the user interface element representing the AI-driven conversational agent or a combination thereof.

In another embodiment, a system for personalized conversational experiences triggered by interactive advertisements with human agent escalation is provided. The system 100 is configured to a client device to process advertisement interaction data locally on a user device, thereby enabling privacy-preserving personalization. Further, an advertisement module receives advertisement interaction metadata generated in response to a user's interaction with a digital advertisement, and an edge router routes the metadata to a microsite server configured to generate a personalized conversational interface. An on-device AI inference engine generates personalized conversational responses without transmitting user-identifiable data, while a secure escalation protocol initiates human agent support when required with maintained privacy protections. Then, a conversational AI session engine, executed by the microsite server, generates the personalized conversational interface using the advertisement interaction metadata, the interface comprising at least one of a text-based interaction, a voice-based interaction, a video-based interaction, or a user interface element representing an AI-driven conversational agent, or a combination thereof. Further, a communication interface transmits the personalized conversational interface to the user device in response to the user interaction, the interface including at least one transaction option. Then, a campaign management portal monitors user interactions with the personalized conversational interface to determine engagement intent and, upon satisfying a predefined escalation condition, facilitates escalation to a human agent through one or more of the interaction modes. Further, an escalation manager detects when a conversation should be transferred and enables seamless transition to the human agent. An analytics engine tracks user engagement metrics and conversion events, while an AI session engine utilizes a large language model with prompt engineering tailored to interpret and act on advertisement metadata. Additionally, a scheduling module enables the user to schedule future meetings within the conversational interface, and a transaction processing module facilitates commercial transactions directly within the interface.

In yet another embodiment, a non-transitory computer-readable medium for personalized conversational experiences triggered by interactive advertisements with human agent escalation is provided. The non-transitory system is configured to a client device to process advertisement interaction data locally on a user device, thereby enabling privacy-preserving personalization. Further, an advertisement module receives advertisement interaction metadata generated in response to a user's interaction with a digital advertisement, and an edge router routes the metadata to a microsite server configured to generate a personalized conversational interface. An on-device AI inference engine generates personalized conversational responses without transmitting user-identifiable data, while a secure escalation protocol initiates human agent support when required with maintained privacy protections. Then, a conversational AI session engine, executed by the microsite server, generates the personalized conversational interface using the advertisement interaction metadata, the interface comprising at least one of a text-based interaction, a voice-based interaction, a video-based interaction, or a user interface element representing an AI-driven conversational agent, or a combination thereof. Further, a communication interface transmits the personalized conversational interface to the user device in response to the user interaction, the interface including at least one transaction option. Then, a campaign management portal monitors user interactions with the personalized conversational interface to determine engagement intent and, upon satisfying a predefined escalation condition, facilitates escalation to a human agent through one or more of the interaction modes. Further, an escalation manager detects when a conversation should be transferred and enables seamless transition to the human agent. An analytics engine tracks user engagement metrics and conversion events, while an AI session engine utilizes a large language model with prompt engineering tailored to interpret and act on advertisement metadata. Additionally, a scheduling module enables the user to schedule future meetings within the conversational interface, and a transaction processing module facilitates commercial transactions directly within the interface.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of artificial intelligence (AI) based conversational advertisement engagement system, in accordance with some embodiments of the present disclosure.

FIG. 2 illustrates an exemplary exploded view of component interaction of the AI based conversational advertisement using the system of FIG. 1, in accordance with some embodiments of the present disclosure.

FIG. 3 illustrates a flow diagram of a method for personalized conversational experiences triggered by interactive advertisements using the system of FIG. 1, in accordance with some embodiments of the present disclosure.

FIG. 4 illustrates exemplary block diagram of AI based conversational advertisement engagement system designed to operate in conjunction with contextual advertisement interaction and chatbot instantiation platform using the system of FIG. 1, in accordance with some embodiments of the present disclosure.

FIG. 5 illustrates an exemplary exploded view of human agent escalation of the AI based conversational advertisement engagement system using the system of FIG. 1, in accordance with some embodiments of the present disclosure.

FIG. 6 illustrates an exemplary exploded view of dynamic AI prompt construction process using the system of FIG. 1, in accordance with some embodiments of the present disclosure.

FIG. 7 illustrates an exemplary exploded view of transaction enabled conversational flow using the system of FIG. 1, in accordance with some embodiments of the present disclosure.

FIG. 8 illustrates an exemplary exploded view of platform agnostic deployment model using the system of FIG. 1, in accordance with some embodiments of the present disclosure.

### DETAILED DESCRIPTION

Exemplary embodiments are described with reference to the accompanying drawings. In the figures, the left-most digit(s) of a reference number identify the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Despite advances in digital advertising and conversational AI, there remains a critical gap between user engagement at the point of advertisement interaction and the delivery of a seamless, personalized experience thereafter. Existing systems rely heavily on redirecting users to static or semi-dynamic landing pages, which fail to preserve the context and intent associated with the originating advertisement. This discontinuity leads to reduced engagement, lower conversion rates, and missed opportunities for real-time personalization. Furthermore, conventional chatbot implementations operate in isolation from advertising ecosystems and lack the ability to dynamically adapt based on advertisement-specific data or user-selected options. They also do not provide efficient mechanisms for escalating interactions to human agents within a unified conversational flow. Accordingly, there is a need for an integrated, technically robust solution that bridges advertisement interaction and conversational engagement by leveraging contextual metadata, enabling real-time personalized interface generation, and supporting seamless escalation, thereby improving user experience, interaction continuity, and overall campaign effectiveness.

Embodiments of the present disclosure provide a system and method for personalized conversational experiences triggered by interactive advertisements with human agent escalation. The system 100 may be alternatively referred to as a privacy-preserving system. The method enables an artificial intelligence (AI) driven conversational interaction in response to user engagement with a digital advertisement. Upon detecting an interaction with a rich media or interactive advertisement, a user device is directed to an interface comprising a microsite configured to automatically instantiate a personalized conversational agent. The conversational agent dynamically adapts its responses based on advertisement interaction data, including campaign parameters, contextual metadata, and user-selected inputs. The system enables real-time conversational engagement through text-based and/or voice-based interfaces and further supports seamless escalation of the interaction to a human agent when a predefined escalation condition is satisfied. Additionally, the system incorporates tracking and analytics mechanisms for capturing user engagement data and interaction outcomes, thereby enabling optimization of advertisement performance and conversational effectiveness.

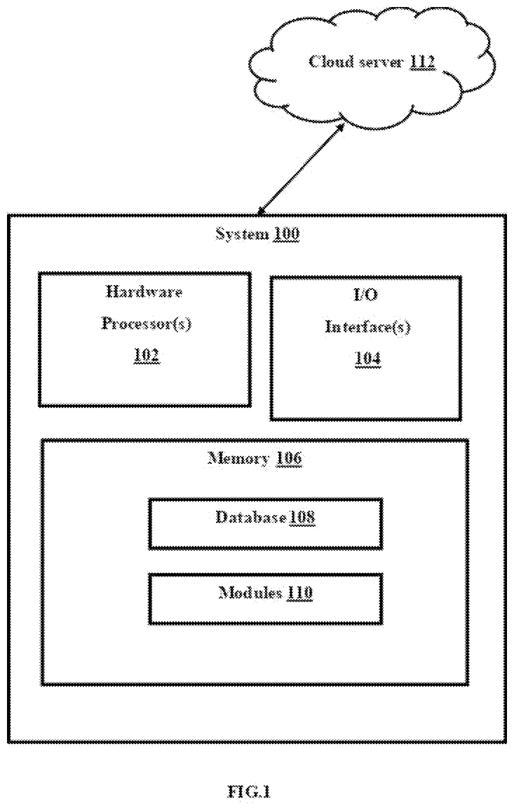

Referring now to the drawings, and more particularly to FIGS. 1 through 8, where similar reference characters denote corresponding features consistently throughout the figures, there are shown preferred embodiments and these embodiments are described in the context of the following exemplary system and/or method.

FIG. 1 is a functional block diagram of artificial intelligence (AI) based conversational advertisement engagement system, in accordance with some embodiments of the present disclosure. In an embodiment, system 100 includes one or more processor(s) 102, communication interface(s), alternatively referred as or input/output (I/O) interface(s) 104, and one or more data storage devices or memory 106 operatively coupled to the one or more hardware processor(s) 102. The system 100 further includes, with the one or more processor(s) is configured to execute functions of one or more functional blocks of the system 100. For example, the processor 102 may be High-performance ARM-based CPU/GPU for parallel processing. More particularly, the processor 102 includes but not limited to an ARM-based, x86, or other CPU/GPU architecture suitable for parallel processing.

In an embodiment, the system 100 includes a cloud server 112, and a plurality of network connections (Not shown in FIGURE). The network connection connects each of corresponding plurality of local instances to the cloud server 112. Similarly, the network connections connect the cloud server 112 and the database 108. In an embodiment, each of the plurality of network connections is a wired communication network or a wireless communication network.

Referring to the components of the system 100, in an embodiment, the one or more processor(s) can be one or more hardware processors 102. In an embodiment, the one or more hardware processors 102 can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud, and the like.

The I/O interface(s) 104 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite, and the like. In an embodiment, the I/O interface(s) 104 can include one or more ports for connecting a number of devices (nodes) of the system 100 to one another or to another server or any kind of hardware components as essential.

The memory 106 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, magnetic tapes, and the like.

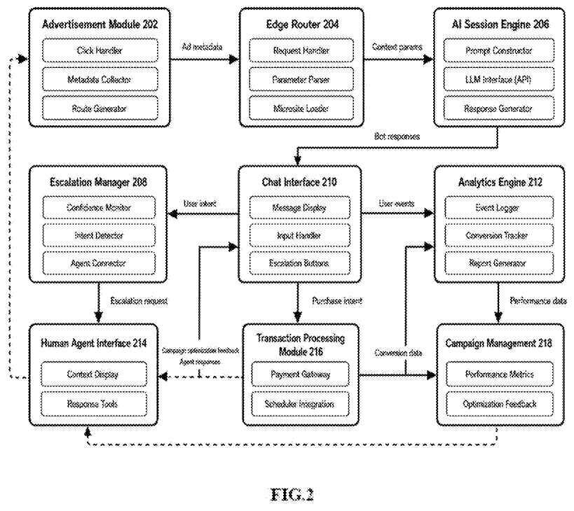

In an embodiment, the memory 106 includes a database 108, and plurality of modules 110 can also include various sub-modules as depicted in FIG. 2. The plurality of modules 110 include programs or coded instructions that supplement applications or functions performed by the system 100 for executing different involved in the process. The plurality of modules 110, amongst other things, can include routines, programs, objects, components, and data structures, which performs particular tasks or implement particular abstract data types. The plurality of modules 110 may also be used as, signal processor(s), node machine(s), logic circuitries, and/or any other device or component that manipulates signals based on operational instructions. Further, the plurality of modules 108 can be used by hardware, by computer-readable instructions executed by the one or more hardware processors 104, or by a combination thereof. The memory 106 may comprise information pertaining to input(s)/output(s) of each step performed by the processor(s) 104 of the system 100 and methods of the present disclosure.

FIG. 2 illustrates an exemplary exploded view of component interaction of the AI based conversational advertisement using the system of FIG. 1, in accordance with some embodiments of the present disclosure.

As illustrated in FIG. 2, the system comprises an integrated architecture for enabling context-aware conversational engagement initiated from a digital advertisement. An Advertisement Module 202 is configured to detect user interaction with an advertisement via a click handler, collect advertisement interaction data through a metadata collector, and generate routing parameters using a route generator. The collected advertisement interaction data is transmitted to an Edge Router 204, which includes a request handler, a parameter parser, and a microsite loader configured to process the incoming data and initialize a context-specific microsite session. The Edge Router 204 forwards context parameters to an AI Session Engine 206, which comprises a prompt constructor, a large language model (LLM) interface, and a response generator configured to dynamically generate personalized conversational responses based on the advertisement interaction data.

The generated responses are delivered to a Chat Interface 210, which includes a message display, an input handler, and escalation controls, thereby enabling real-time user interaction through text, voice, or a combination thereof. User interaction data and events from the Chat Interface 210 are transmitted to an Analytics Engine 212, which includes an event logger, a conversion tracker, and a report generator configured to capture engagement metrics and generate performance insights. The Analytics Engine 212 further communicates with a Campaign Management Module 218 to provide performance data and receive optimization feedback for improving subsequent advertisement targeting and interaction strategies.

The system further includes an Escalation Manager 208 configured to monitor user intent using a confidence monitor and an intent detector. Upon determining that a predefined escalation condition is satisfied, the Escalation Manager 208 generates an escalation request to a Human Agent Interface 214, which provides context display and response tools to enable a human agent to seamlessly continue the interaction while maintaining conversation context. Additionally, the Chat Interface 210 may trigger a Transaction Processing Module 216 upon detecting a purchase intent, wherein the Transaction Processing Module 216 includes a payment gateway and scheduler integration for completing transactions or scheduling actions within the conversational flow. The system thus ensures a continuous, context-preserving interaction pipeline from advertisement engagement to AI-driven conversation, transaction processing, human escalation, and performance optimization.

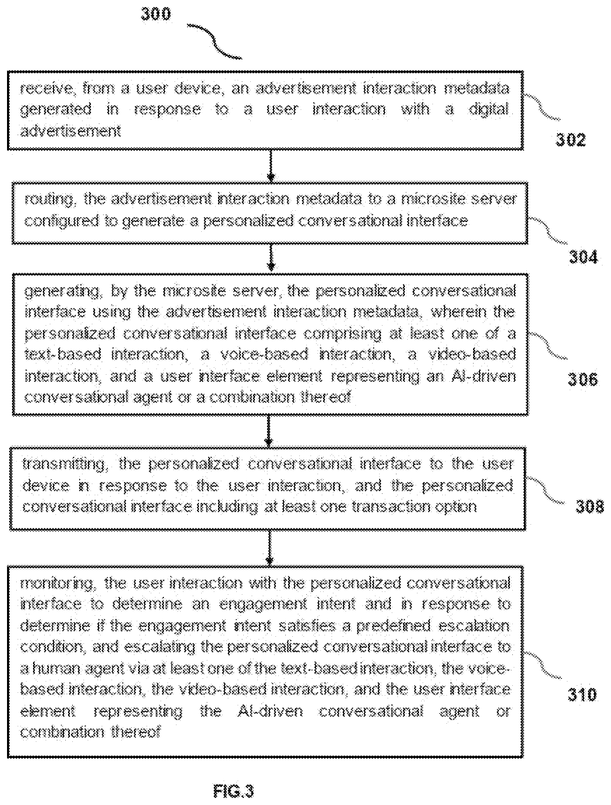

FIG. 3 illustrates a flow diagram of a method for personalized conversational experiences triggered by interactive advertisements using the system of FIG. 1, in accordance with some embodiments of the present disclosure.

In an embodiment, the system 100 comprises one or more data storage devices or the memory 106 operatively coupled to the one or more hardware processor(s) 104 and is configured to store instructions for execution of steps of a method 300 by the processor(s) or one or more hardware processors 104. The steps of the method 300 of the present disclosure will now be explained with reference to the components or blocks of the system 100 as depicted in FIG. 1 through FIG. 8, and the steps of flow diagram as depicted in FIG. 3. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring to the steps of the method 300, at step 302 one or more hardware processor is configured to receive from a user device, an advertisement interaction metadata generated in response to a user interaction with a digital advertisement.

Referring now to an real time use case example, where a user browsing a mobile application who is served a targeted real estate advertisement offering “Book a Site Visit for Luxury Apartments.” When the user clicks the advertisement, the advertisement module 202 captures interaction data such as campaign ID, location, device type, and the selected option (e.g., “Schedule Visit”). This data is immediately passed to the edge router 204, which parses the parameters and loads a dedicated microsite session tailored to the advertisement context.

At step 304 of the method 300 one or more hardware processor is configured to route the advertisement interaction metadata to a microsite server configured to generate a personalized conversational interface.

Once the data is immediately passes, the AI Session Engine 206 then dynamically constructs a conversational prompt using the received metadata for example, preloading details about the specific property, pricing range, and nearby locations and generates a personalized chatbot interface. This interface is rendered through the Chat Interface 210, where the user is greeted with a contextual message such as, “Would you like to schedule a visit this weekend or explore available floor plans?” The user interacts in real time, asking questions about pricing, availability, and amenities.

The AI Session Engine 206 dynamically constructs chatbot prompts by combining a base system message with tokenized campaign metadata. Parameters such as utm_campaign, utm_term, adgroup_id, and geolocation are mapped to pre-defined intent templates or prompt modifiers. These elements are injected into a system prompt structure that initializes the LLM with a persona and task scope aligned with the advertising campaign's message. This mapping may be rule-based or trained using reinforcement learning based on user engagement performance.

The system provides a comprehensive Subscriber Campaign Management Portal enabling advertisers to create, deploy, monitor, and optimize conversational experiences linked to their advertising campaigns. This portal interface comprises multiple integrated components including a campaign dashboard displaying active conversational campaigns with real-time performance metrics, knowledge base management tools, analytics visualization, agent management interfaces, and integration setup options. The portal's design allows non-technical marketing personnel to effectively leverage advanced AI conversational capabilities by providing intuitive interfaces for uploading knowledge bases, configuring AI personas, establishing escalation parameters, and monitoring performance metrics including engagement rates, conversion data, and return on advertising spend.

The system provides a specialized interface for Chatbot Creation and Knowledge Base Training that enables advertisers to rapidly configure conversational experiences customized to specific advertising campaigns. Through this interface, advertisers upload relevant content such as product catalogs, FAQs, and promotional material, which the system automatically processes into knowledge chunks optimized for retrieval during conversations.

There is a campaign analytics and performance dashboard, a data-driven monitoring and optimization interface that provides advertisers with comprehensive insights into their conversational advertising campaigns. The dashboard displays key performance indicators including total conversations, conversion rate, escalation rate, and average order value, presented in an intuitive format with trend visualization over configurable time periods. The dashboard further includes an AI-powered insights section that automatically generates optimization recommendations based on identified patterns, knowledge gaps, and conversion bottlenecks.

Further, at step 306 of the method 300 one or more hardware processor is configured to generate, by the microsite server, the personalized conversational interface using the advertisement interaction metadata, wherein the personalized conversational interface comprising at least one of a text-based interaction, a voice-based interaction, a video-based interaction, and an user interface element representing an AI-driven conversational agent or a combination thereof.

The microsite server is configured to generate a personalized conversational interface based on advertisement interaction metadata received from a user device. The generation process utilizes the metadata, including user-selected options and contextual information associated with the advertisement interaction, to dynamically construct a context-aware conversational experience. The personalized conversational interface is configured to support at least one interaction modality, including a text-based interaction, a voice-based interaction, or a combination thereof, thereby enabling flexible and adaptive user engagement. The interface may further incorporate contextual prompts, responses, and interaction flows tailored to the user's intent and advertisement context, ensuring a coherent and responsive conversational experience.

Then, at step 308 of the method 300 one or more hardware processor is configured to transmit, the personalized conversational interface to the user device in response to the user interaction, and the personalized conversational interface including at least one transaction option.

The personalized conversational interface is dynamically generated based on advertisement interaction metadata and is configured to support one or more modes of interaction, including text-based and voice-based communication. The interface further comprises at least one transaction option, presented in a contextually relevant manner within the conversational flow, to enable the user to initiate and complete a transaction without exiting the interface. The transaction option may include, but is not limited to, (i) complete a purchase directly within the conversational interface, navigating to an external website, (ii) scan a dynamically generated QR code, and initiating a mobile payment, (iii) voice-activated purchasing, (iv) buy-now-pay-later integration, (v) social commerce sharing that allows purchasing through shared links, and (vi) augmented reality product visualization with in-view purchase capability, and (vii) one-click reorder functionality for returning customers.

The transaction option is dynamically selected based on the advertisement interaction metadata and a user interaction pattern.

Here, completing the purchase directly within the conversational interface comprises maintaining a conversation context throughout a transaction process, and triggering a notification to an advertisement agency for attribution and analytics purpose.

The advertisement interaction metadata includes at least one of a campaign identifiers, an audience segment data, a geographic location, a device type, a creative variant, and an engagement time.

In one embodiment, the user is provided with a selectable option to schedule a future meeting, receiving the user input indicative of a preferred time and date, and automatically initiating a scheduling process based on the received input. Here, scheduling the future meeting comprises integrating with a third-party scheduling service while maintaining a conversation context.

Also, the user is offered with an option to schedule a future meeting as an alternative to immediate escalation to the human agent. The transferred conversation context to the scheduled meeting to maintain continuity of the user experience.

In one embodiment, the human agent is provided with historical context of the conversation and relevant campaign information through an agent dashboard interface. Also, the method logs one or more escalation events and resolutions for future campaign and the AI conversation optimization.

Finally, at step 310 of the method 300 one or more hardware processor is configured to monitor, the user interaction with the personalized conversational interface to determine an engagement intent and in response to determine if the engagement intent satisfies a predefined escalation condition, and escalating the personalized conversational interface to a human agent via at least one of the text-based interaction, the voice-based interaction, the video-based interaction, and the user interface element representing the AI-driven conversational agent or a combination thereof.

As the interaction progresses, the analytics engine 212 logs user events and tracks engagement signals, while the escalation manager 208 continuously evaluates user intent. If the user asks complex questions (e.g., legal documentation or negotiation), the system detects a high-value intent and triggers escalation. The conversation is seamlessly handed off to a human sales agent via the human agent interface 214, with full context preserved, allowing the agent to respond without requiring the user to repeat information.

If the user proceeds with booking, the transaction processing module 216 enables scheduling a site visit by integrating with a calendar system, all within the same conversational interface. The interaction outcome, including conversion data, is fed back to the Campaign Management Module 218, which uses the insights to optimize future ad targeting and messaging. This real-time flow ensures a frictionless transition from advertisement engagement to personalized interaction, transaction completion, and human-assisted support, significantly improving user experience and conversion efficiency.

The predefined escalation condition is based on at least one of detected user intent, a sentiment analysis, a confidence score threshold, a specific user request, an idle timeout period and an interaction duration.

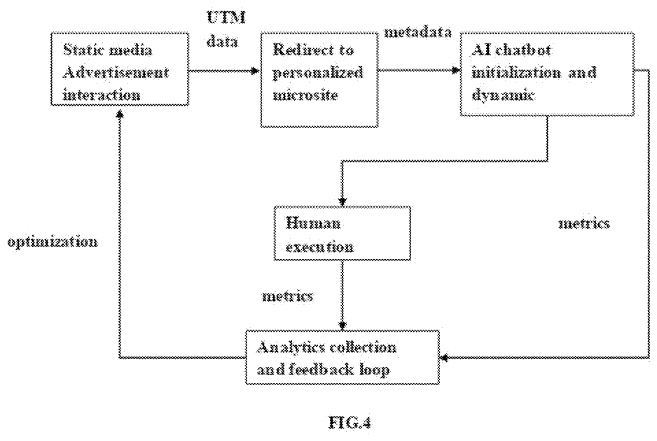

FIG. 4 illustrates an exemplary block diagram of AI based conversational advertisement engagement system designed to operate in conjunction with contextual advertisement interaction and chatbot instantiation platform using the system of FIG. 1, in accordance with some embodiments of the present disclosure.

As illustrated in the FIG. 4, the system 100 comprises a sequence of interconnected components that enable a seamless transition from advertisement interaction to personalized conversational engagement. The system 100 receives interaction data when a user device interacts with a digital advertisement, which generates an advertisement interaction data that is transmitted to a routing layer. The routing layer directs the interaction data to a microsite server, which is configured to instantiate a context-aware conversational interface. The microsite server dynamically generates an AI-driven personalized chatbot using the received advertisement interaction data, including user-selected inputs and contextual metadata. The generated conversational interface is then delivered back to the user device, enabling real-time interaction through text, voice, or a combination thereof. The system further includes a monitoring module that continuously evaluates user engagement and intent during the interaction. Upon detecting that a predefined escalation condition is satisfied, the system facilitates seamless escalation of the conversation to a human agent via appropriate communication channels such as chat, audio, or video. This architecture ensures continuity of context, enhances user engagement, and supports efficient conversion and interaction outcomes.

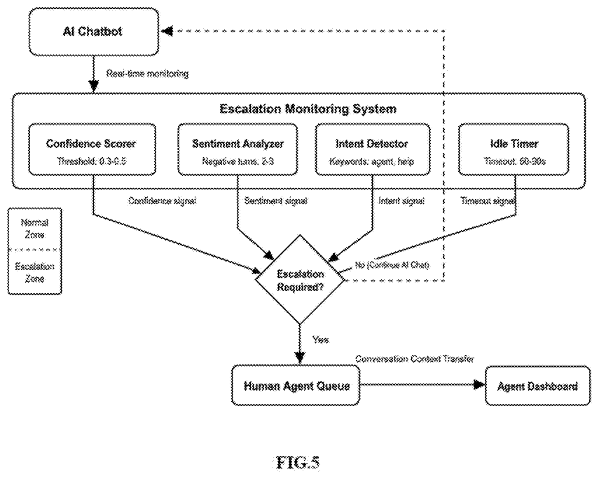

FIG. 5 illustrates an exemplary exploded view of human agent escalation of the AI based conversational advertisement engagement system using the system of FIG. 1, in accordance with some embodiments of the present disclosure.

As illustrated in FIG. 5, an escalation monitoring system is configured to operate in conjunction with an AI chatbot to enable intelligent, real-time escalation of conversational interactions to a human agent. The AI chatbot continuously exchanges messages with a user while simultaneously providing interaction data to the escalation monitoring system for real-time evaluation. The escalation monitoring system comprises a plurality of analytical components, including a confidence scorer configured to compute a response confidence level associated with chatbot outputs, a sentiment analyzer configured to detect user sentiment across one or more conversational turns, an intent detector configured to identify escalation-related intents based on predefined keywords or inferred user objectives, and an idle timer configured to detect inactivity exceeding a predefined timeout threshold.

Each of these components generates corresponding signals, including a confidence signal, a sentiment signal, an intent signal, and a timeout signal, which are collectively evaluated to determine whether an escalation condition is satisfied. The system may define operational zones, including a normal interaction zone and an escalation zone, based on threshold values such as confidence ranges, sentiment polarity, frequency of negative responses, detected escalation keywords, or user inactivity duration. When the combined evaluation indicates that escalation is not required, the interaction continues with the AI chatbot. Conversely, when the escalation condition is satisfied, the system generates an escalation request and routes the ongoing conversation to a human agent queue.

Upon escalation, the complete conversational context, including prior messages, detected intents, and relevant metadata, is transferred to an agent dashboard accessible by a human agent. This enables the human agent to seamlessly continue the interaction without requiring the user to restate information. The system thereby ensures efficient handoff from automated to human-assisted interaction, improving resolution accuracy, user satisfaction, and overall engagement quality.

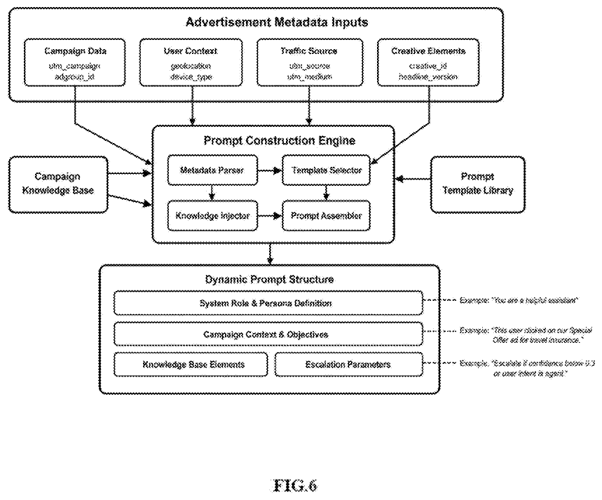

FIG. 6 illustrates an exemplary exploded view of dynamic AI prompt construction process using the system of FIG. 1, in accordance with some embodiments of the present disclosure.

FIG. 6 illustrates where the system 100 integrates multiple advertisement metadata inputs, including campaign data, user context, traffic source information, and creative elements, which are processed through a prompt construction engine comprising a metadata parser, template selector, knowledge injector, and prompt assembler. The engine interacts with a campaign knowledge base and a prompt template library to generate context-aware and personalized prompts. These prompts are structured dynamically to include system role definitions, campaign objectives, relevant knowledge base elements, and escalation parameters, thereby enabling adaptive, efficient, and goal-oriented user engagement. The invention improves the relevance, consistency, and performance of AI-generated responses in advertising workflows while supporting real-time customization based on user behavior and campaign strategies.

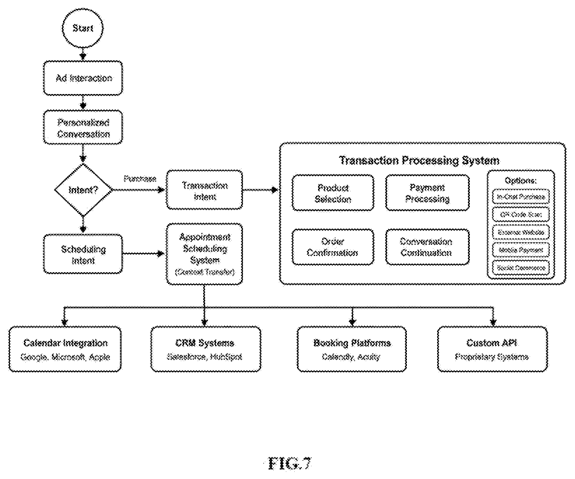

FIG. 7 illustrates an exemplary exploded view of transaction enabled conversational flow using the system of FIG. 1, in accordance with some embodiments of the present disclosure.

The FIG. 7 initiates with an advertisement interaction that triggers a personalized conversation with a user, followed by real-time intent detection to classify the user's objective as either a transaction intent or a scheduling intent. Upon identifying a purchase-related intent, the system routes the interaction to a transaction processing module comprising product selection, payment processing, order confirmation, and conversation continuation components, with multiple fulfillment options including in-chat purchases, QR code-based transactions, external website redirection, mobile payments, and social commerce channels. In the case of scheduling intent, the system transfers context to an appointment scheduling module configured to integrate with external calendar services, customer relationship management (CRM) systems, and third-party booking platforms. The architecture further supports interoperability through custom application programming interfaces (APIs), enabling seamless data exchange with proprietary systems. This invention enhances user experience by providing a unified, adaptive framework for handling both commerce and scheduling interactions within a single conversational interface, improving efficiency, conversion rates, and system scalability.

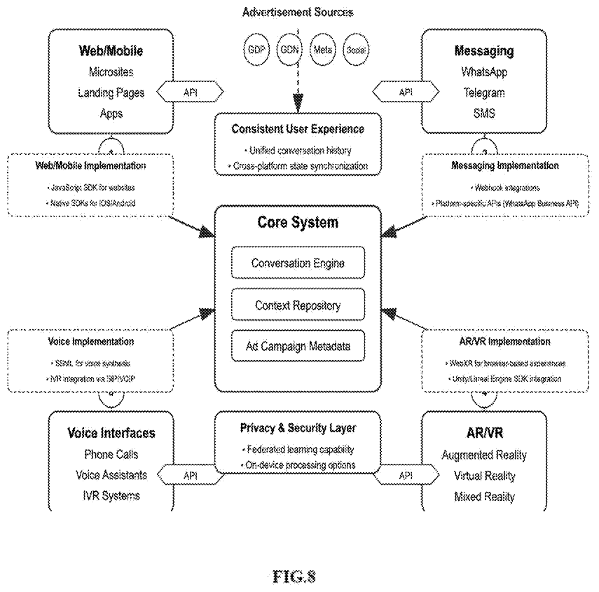

FIG. 8 illustrates an exemplary exploded view of platform agnostic deployment model using the system of FIG. 1, in accordance with some embodiments of the present disclosure.

The FIG. 8 supports platform-specific implementations, including software development kits (SDKs) for web and mobile applications, webhook and API-based integrations for messaging platforms, speech synthesis and interactive voice response (IVR) systems for voice interfaces, and extended reality frameworks for AR/VR environments. A privacy and security layer is incorporated to ensure data protection, incorporating features such as federated learning and on-device processing to minimize data exposure. The system is configured to maintain a unified conversation history and synchronize user state across all supported channels, thereby enabling a seamless and continuous user journey. Advantageously, the disclosed system enhances interoperability, scalability, and user engagement by providing a cohesive and adaptive conversational experience across heterogeneous digital and immersive environments.

The embodiments of the present disclosure address absence of for personalized conversational experiences triggered by interactive advertisements with human agent escalation. In various embodiments of the present disclosure, the system is configured to support platform-agnostic deployment, wherein conversational chatbot experiences are consistently delivered across a plurality of digital channels, including but not limited to websites, mobile applications, messaging platforms, voice-enabled assistants, augmented reality (AR) interfaces, and wearable devices. The system maintains persistent personalization parameters and conversational context, thereby enabling seamless transition of user interactions across heterogeneous platforms while preserving conversation history and state continuity.

In certain embodiments, the system further supports voice and augmented reality integration, wherein conversational experiences are initiated through voice-activated advertisements or AR-enabled interactive content. Such embodiments may utilize voice recognition, spatial anchoring, or contextual environmental inputs to enable context-aware and immersive conversational interactions.

In some embodiments, the system incorporates federated and privacy-preserving artificial intelligence mechanisms, including federated learning models and on-device inference capabilities, to enhance data security, reduce latency, and ensure compliance with privacy requirements. The system may further implement anonymization techniques, contextual privacy controls, and user consent management mechanisms throughout the lifecycle of the conversational interaction. Privacy-preserving protocols may also extend to escalation processes involving human agents to ensure secure handling of user data.

In additional embodiments, the system enables multimodal interaction interfaces, integrating multiple communication modalities including text, audio, video, and gesture-based inputs to provide enriched and adaptive conversational experiences initiated through advertisement interactions.

In certain embodiments, the system includes a predictive escalation mechanism, utilizing machine learning and analytical models to identify indicators of user dissatisfaction or escalation intent. The system proactively transitions interactions to human agents based on predefined thresholds and signals, while ensuring complete transfer of conversational context. The escalation framework may further include resolution tracking and feedback loops to continuously improve AI-driven interactions.

In some embodiments, the system provides an integrated agent dashboard configured to enable human agents to monitor, manage, and intervene in real-time conversational sessions. The dashboard may present historical conversation data, analytical insights, and controls for seamless transition between automated and human-assisted interactions.

In further embodiments, the system supports retargeting integration, wherein user interaction data and chatbot analytics are utilized to dynamically adjust subsequent advertisements, campaign strategies, or conversational behaviors to improve engagement and conversion outcomes.

In certain embodiments, the system enables transaction-capable conversational workflows, wherein users can complete commercial transactions directly within the conversational interface. The system dynamically presents contextually relevant transaction options based on advertisement metadata and conversation state, supporting multiple payment modalities while maintaining conversational continuity. In additional embodiments, the system includes appointment scheduling integration, allowing users to schedule meetings or appointments within the conversational flow. The system preserves contextual information during scheduling operations and facilitates integration with external calendar systems and scheduling platforms, thereby ensuring a seamless and uninterrupted user experience.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs, GPUs and edge computing devices.

1. A processor-implemented method for initiating a personalized conversational interaction from a digital advertisement, the method comprising:
receiving, from a user device, an advertisement interaction metadata generated in response to a user interaction with a digital advertisement;
routing, the advertisement interaction metadata to a microsite server configured to generate a personalized conversational interface;
generating, by the microsite server, the personalized conversational interface using the advertisement interaction metadata, wherein the personalized conversational interface comprising at least one of a text-based interaction, a voice-based interaction, a video-based interaction, and an user interface element representing an AI-driven conversational agent or a combination thereof;
transmitting, the personalized conversational interface to the user device in response to the user interaction, and the personalized conversational interface including at least one transaction option; and
monitoring, the user interaction with the personalized conversational interface to determine an engagement intent and in response to determine if the engagement intent satisfies a predefined escalation condition, and escalating the personalized conversational interface to a human agent via at least one of the text-based interaction, the voice-based interaction, the video-based interaction, and the user interface element representing the AI-driven conversational agent or a combination thereof.

2. The processor-implemented method as claimed in claim 1, wherein generating the personalized conversational interface comprises initializing an artificial intelligence session using a prompt content selected from a plurality of pre-configured conversation templates based on the advertisement interaction data.

3. The processor-implemented method as claimed in claim 1, wherein the predefined escalation condition is based on at least one of detected user intent, a sentiment analysis, a confidence score threshold, a specific user request, an idle timeout period and an interaction duration.

4. The processor-implemented method as claimed in claim 1, wherein the advertisement interaction metadata includes at least one of a campaign identifiers, an audience segment data, a geographic location, a device type, a creative variant, and an engagement time.

5. The processor-implemented method of claim 1, wherein providing, a selectable option to the user to schedule a future meeting, receiving the user input indicative of a preferred time and date, and automatically initiating a scheduling process based on the received input.

6. The processor-implemented method as claimed in claim 1, wherein the transaction option includes at least one of: (i) complete a purchase directly within the conversational interface, navigating to an external website, (ii) scan a dynamically generated QR code, and initiating a mobile payment, (iii) voice-activated purchasing, (iv) buy-now-pay-later integration, (v) social commerce sharing that allows purchasing through shared links, and (vi) augmented reality product visualization with in-view purchase capability, and (vii) one-click reorder functionality for returning customers.

7. The processor-implemented method as claimed in claim 1, wherein providing the human agent with historical context of the conversation and relevant campaign information through an agent dashboard interface.

8. A privacy-preserving system for initiating a personalized conversational interaction from a digital advertisement, comprising:
a memory storing instructions;
one or more communication interfaces; and
one or more hardware processors coupled to the memory via the one or more communication interfaces, wherein the one or more hardware processors are configured by the instructions to:
a client device configured to process advertisement interaction data locally on a user device;
an advertisement module receives from a user device, an advertisement interaction metadata generated in response to the user interaction with a digital advertisement;
an edge router routes the advertisement interaction metadata to a microsite server configured to generate a personalized conversational interface;
an on-device AI inference engine configured to generate a one or more personalized conversational responses without transmitting user-identifiable data;
a secure escalation protocol configured to initiate a human agent support when required while maintaining privacy protections;
a conversational AI session engine generates by the microsite server, the personalized conversational interface using the advertisement interaction metadata, wherein the personalized conversational interface comprising at least one of a text-based interaction, a voice-based interaction, a video-based interaction and an user interface element representing an AI-driven conversational agent or a combination thereof;
a communication interface transmits the personalized conversational interface to the user device in response to the user interaction, and the personalized conversational interface including at least one transaction option;
a campaign management portal monitors the user interaction with the personalized conversational interface to determine an engagement intent and in response to determine if the engagement intent satisfies a predefined escalation condition, and escalating the personalized conversational interface to a human agent via at least one of the text-based interaction, a voice-based interaction, a video-based interaction and an user interface element representing an AI-driven conversational agent or a combination thereof;
an escalation manager detect when a conversation should be transferred to a human agent and to facilitate seamless transition of the conversation;
an analytics engine tracks user engagement metrics and conversion events throughout the conversational experience;
a AI session engine utilizes a large language model with prompt engineering specifically tailored to interpret and act on advertisement metadata;
a scheduling module enables the user to schedule a future meeting during the personalized conversational interface; and
a transaction processing module configured to facilitate commercial transactions directly within the personalized conversational interface.

9. The privacy-preserving system as claimed in claim 8, wherein generating the personalized conversational interface comprises initializing an artificial intelligence session using a prompt content selected from a plurality of pre-configured conversation templates based on the advertisement interaction data.

10. The privacy-preserving system as claimed in claim 8, wherein the predefined escalation condition is based on at least one of detected user intent, a sentiment analysis, a confidence score threshold, a specific user request, an idle timeout period and an interaction duration.

11. The privacy-preserving system as claimed in claim 8, wherein the advertisement interaction metadata includes at least one of a campaign identifiers, an audience segment data, a geographic location, a device type, and an engagement time.

12. The privacy-preserving system as claimed in claim 8, wherein providing, a selectable option to the user to schedule a future meeting, receiving the user input indicative of a preferred time and date, and automatically initiating a scheduling process based on the received input.

13. The privacy-preserving system as claimed in claim 8, wherein the transaction option includes at least one of: (i) complete a purchase directly within the conversational interface, navigating to an external website, (ii) scan a dynamically generated QR code, and initiating a mobile payment, (iii) voice-activated purchasing, (iv) buy-now-pay-later integration, (v) social commerce sharing that allows purchasing through shared links, and (vi) augmented reality product visualization with in-view purchase capability, and (vii) one-click reorder functionality for returning customers.

14. The privacy-preserving system as claimed in claim 8, wherein providing the human agent with historical context of the conversation and relevant campaign information through an agent dashboard interface.

15. The privacy-preserving system as claimed in claim 8, wherein the transaction processing module is configured to generate a transaction-specific QR code that, when scanned, directs the user to a pre-populated checkout page.

16. The privacy-preserving system of claim 8, wherein the on-device AI inference engine utilizes federated learning techniques to improve response quality without centralizing user data.

17. The privacy-preserving system of claim 8, wherein the secure escalation protocol includes anonymization of conversation transcripts before transmission to human agents.

18. The privacy-preserving system of claim 8, further comprising a consent management interface allowing users to control what data may be processed during the conversational experience.

19. The privacy-preserving system of claim 8, wherein the campaign management portal comprises a knowledge-base ingestion and a retrieval-augmented generation (RAG) pipeline configured to receive campaign-specific content from an advertiser.

20. A non-transitory computer-readable medium including instructions that, when executed by a processor, cause the processor to perform:
a client device configured to process advertisement interaction data locally on a user device;
an advertisement module receives from a user device, an advertisement interaction metadata generated in response to the user interaction with a digital advertisement;
an edge router routes the advertisement interaction metadata to a microsite server configured to generate a personalized conversational interface;
an on-device AI inference engine configured to generate a one or more personalized conversational responses without transmitting user-identifiable data;
a secure escalation protocol configured to initiate a human agent support when required while maintaining privacy protections;
a conversational AI session engine generates by the microsite server, the personalized conversational interface using the advertisement interaction metadata, wherein the personalized conversational interface comprising at least one of a text-based interaction, a voice-based interaction, a video-based interaction and an user interface element representing an AI-driven conversational agent or a combination thereof;
a communication interface transmits the personalized conversational interface to the user device in response to the user interaction, and the personalized conversational interface including at least one transaction option;
a campaign management portal monitors the user interaction with the personalized conversational interface to determine an engagement intent and in response to determine if the engagement intent satisfies a predefined escalation condition, and escalating the personalized conversational interface to a human agent via at least one of the text-based interaction, a voice-based interaction, a video-based interaction and an user interface element representing an AI-driven conversational agent or a combination thereof;
an escalation manager detect when a conversation should be transferred to a human agent and to facilitate seamless transition of the conversation;
an analytics engine tracks user engagement metrics and conversion events throughout the conversational experience;
a AI session engine utilizes a large language model with prompt engineering specifically tailored to interpret and act on advertisement metadata;
a scheduling module enables the user to schedule a future meeting during the personalized conversational interface; and
a transaction processing module configured to facilitate commercial transactions directly within the personalized conversational interface.
